(19) United States
(12) Patent Application Publication
(10) Pub. No.: US 2012/0202134 A1
(43) Pub. Date: Aug. 9, 2012

(54) REDUCED THERMAL CONDUCTIVITY IN PEM FUEL CELL GAS DIFFUSION LAYERS

(76) Inventors: Paravastu Badrinarayanan, Manchester, CT (US); Robert M. Darling, South Windsor, CT (US); Jonathan D. O'Neill, Manchester, CT (US)

(21) Appl. No.: 13/261,250

(22) PCT Filed: Oct. 8, 2009
(86) PCT No.: PCT/US2009/005562

§ 371 Date: Apr. 2, 2012

(51) Int. Cl. H01M 8/10

(52) U.S. Cl. 429/480

(57) ABSTRACT

A fuel cell for a fuel cell power plant having gas diffusion layers which do not have microporous layers, includes a PEM (9), a cathode comprising at least a cathode catalyst (10) and a gas diffusion layer (17) on one side of the PEM, and an anode comprising at least an anode catalyst (11) and a gas diffusion layer (14) on the opposite side of the PEM, and a porous water transport plate having reactant gas flow field channels (31, 32) (21, 28) adjacent to each of said support substrates as well as water flow channels (22) in at least one of said water transport plates. The thermal conductivity of the cathode and/or the anode gas dif- fusion layers is less than about one-quarter of the thermal conductivity of conventional gas diffusion layers, less than about 0.25 W/m/K, to promote flow of water from the cathodes to the anodes and to the adjacent water transport plates, during start-up at normal ambient temperatures (lower than normal PEM fuel cell operating temperatures).

### TECHNICAL FIELD

PEM fuel cells are fitted with gas diffusion layers on either or both of the anode and cathode which have lower than normal thermal conductivity, increasing the temperature gradient across the gas diffusion layer to enhance movement of water across the gas diffusion layer and away from the interface with catalysts.

### BACKGROUND ART

One of the reasons that proton exchange membrane (PEM) fuel cells are thought to be attractive for automotive applications is that they are self-starting in the sense that they heat on their own from the process, and there is no need for an external heat source to bring them to an operating temperature before operation can be sustained. However, in some instances, the rate at which the power output of the fuel cell will increase when it is started at typical room temperatures (25C, 77F) is slower than desired, particularly in vehicular applications.

PEM fuel cells have a gas diffusion layer (GDL) adjacent both electrode catalyst layers. The GDLs have large pores, such as on the order of 75 micrometers. In some fuel cell stacks, the GDLs (particularly those adjacent the anode, may have a microporous layer, sometimes called a “bilayer” between the GDL and the reactant flow fields; the microporous layers have pore diameters well below one micrometer.

For PEM fuel cell operation, cathode water removal and management is critical to obtain good performance. The product water is removed typically in a combination of liquid and vapor from the cathode catalyst layer where it is produced. If a significant portion is removed as liquid, it might result in flooding of the catalyst layer, the GDL or the interface between the catalyst layer and the GDL, which can reduce the performance of the fuel cell. To remove water as vapor when liquid water is present (i.e., if the temperature is high enough, water vapor will form automatically), there would need to be a favorable gradient in the partial pressure of water vapor from the catalyst layer-GDL interface to the GDL-flow field interface. A simple analysis of impact of temperature on vapor transport is shown below.

Referring to FIG. 1, a curve of saturated water vapor pressure illustrates that at a lower temperature (around T1 and T2), it takes a greater temperature difference (ΔT₁) in order to achieve the same saturated vapor pressure gradient (ΔPv₁; (ΔPv₂) across a gas diffusion layer than the temperature gradient (ΔT₂) between T3 and T4. Thus, if the fuel cell is to be started up at temperatures around T1 or T2, a larger temperature gradient across the gas diffusion layer would be required than at normal operating temperature, which might be on the order of T3 and T4, in order to have the benefit of the same gradient in partial pressure, or equally concentration, of water.

At a temperature around 25C (77F) product water produced at the cathode is not removed as vapor to a sufficient extent. Hence, there is a need to remove more of the product water in the liquid phase to avoid flooding of the catalyst layer, the GDL, or the cathode interface with the gas diffusion layer.

Conventionally, it has been considered good practice to employ GDLs with high thermal conductivity which not only results in better heat transport (to assist in lowering hot spots, if any) but also because high thermal conductivity is related to lower electrical resistance, resulting in lower ohmic losses.

A common configuration includes a gas diffusion layer fitted with a microporous layer. The combination will help with water management, due in part to a lower overall (combined) thermal conductivity, as well as other factors. However, the propensity for microporous layer oxidation that lowers fuel cell life, as well as other considerations, results in microporous layers not being utilized in many instances.

Therefore, lowering the thermal conductivity of the gas diffusion itself will assist in start-up of PEM fuel cells from normal temperatures.

### SUMMARY

Gas diffusion layers which are devoid of microporous layers, in either or both of the anode and cathode of proton exchange membrane fuel cells, are caused to have thermal conductivity of between about 0.08 W/m/K and 0.25 W/m/K. In one embodiment, both the cathodes and the anodes will have gas diffusion layers of low thermal conductivity. In another embodiment, the anode gas diffusion layer may have a normal conductivity, such as between about 1.0 W/m/K and 1.5 W/m/K, while the cathodes will have thermal conductivity of between about 0.08 W/m/K and 0.25 W/m/K.

A feature of the embodiments herein is that although a gas diffusion layer (GDL) having low thermal conductivity can significantly increase performance (voltage vs. current density) at lower temperatures (vicinity of 25C, 77F), the same GDL provides substantially the same performance at normal PEM fuel cell operating temperatures (such as between about 65C and 80C; 150F-175F). The improved cool start performance due to providing lower thermal conductivity to GDLs without a microporous layer does not impact operation at normal operating temperature. The increase in ohmic losses, due to the poorer electrical conductivity of the GDLs with lower thermal conductivity, is minimal.

Other variations will become more apparent in the light of the following detailed description of exemplary embodiments, as illustrated in the accompanying drawings.

### BRIEF DESCRIPTION OF THE DRAWINGS

FIG. 1 is a curve of saturated water vapor pressure.

FIG. 2 is a fractional side elevation view of a typical fuel cell which can improve cool startup with GDLs having reduced thermal conductivity.

FIG. 3 is a performance curve using gas diffusion layers on both the anode and the cathode with conventional thermal conductivity, such as on the order of 1.0-1.5 W/m/K, operating at 25C (77F).

FIG. 4 is a performance curve of a PEM fuel cell operating at 65C (150F), comparing gas diffusion layers with low thermal conductivity (upper curve) and with high thermal conductivity (lower curve).

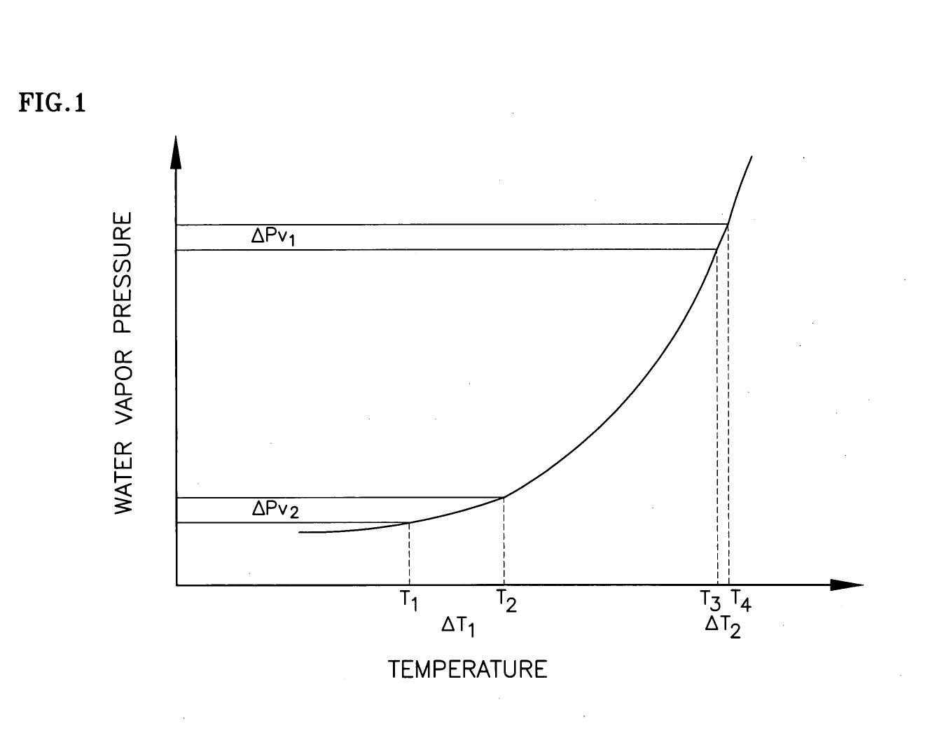

### MODE(S) OF IMPLEMENTATION

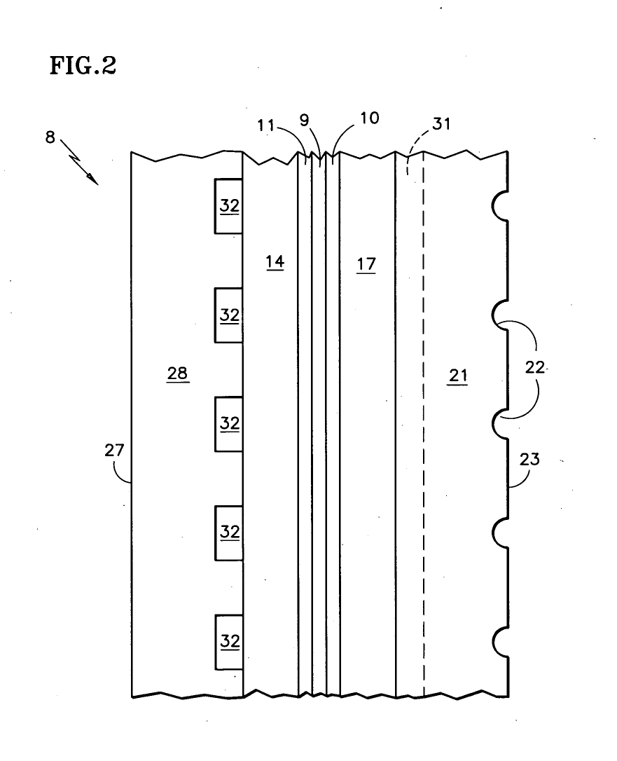

Referring to FIG. 2, a fuel cell 8, which typically is used in a stack with other fuel cells in a known fashion, includes a polymer electrolyte, proton exchange membrane 9 having a cathode catalyst layer 10 on one surface thereof and an anode catalyst layer 11 on an opposing surface thereof. The anode has a gas diffusion layer 14 which may be hydrophilic, partially hydrophilic, or hydrophobic but does not have a microporous layer. The cathode has a gas diffusion layer 17 which may be hydrophilic, partially hydrophilic, or hydrophobic, but does not have a microporous layer.

Adjacent each of the gas diffusion layers is a porous, hydrophilic reactant flow field plate, in this instance of the type referred to as a “water transport plate”. A cathode water transport plate 21 has water flow channels 22 in a surface 23 thereof, which, when the fuel cell 8 is adjacent to a similar fuel cell having a flat surface 27 on an anode water transport plate 28, will provide water flow channels. Or the water flow fields may be completed by the surface 23 being butted against a flat surface of a solid separator plate or a cooler plate; in such a case, the anode water transport plate 28 will have water flow channels similar to channels 22. Alternatively, either flow field plate may be a solid plate in which case at least a portion of water removal is accomplished by evaporation and entrainment as are known.

The cathode water transport plate 21 has oxidant reactant gas flow fields, such as air flow fields 31, and the anode water transport plate 28 has fuel reactant gas flow fields 32.

A typical gas diffusion layer 14 is fabricated with long fiber PAN (polyacrylonitrile) based carbon fibers and has a thermal conductivity through the plane of about 1.2 watts per meter per degree C. (W/m° C.). The thickness of the anode substrate 14 is typically about 0.18 mm; the thermal conductance of such a substrate is therefore about 6.7×10³ W/m²° C.

As disclosed in U.S. Pat. No. 7,429,429 (incorporated herein by reference), one way of causing the decreased thermal conductance of the gas diffusion layers is by changing the heat treat temperature of the material, or altering the polymer content of the carbon black layers. Thermal conductivity of the substrates can be decreased by using a PAN based carbon fiber rather than a pitch based carbon fiber or by using longer, chopped fibers (on the order of 5.0 mm to 10.0 mm) in place of using short milled fibers (on the order of 0.25 mm to 0.50 mm). The thermal conductivity may be changed by using carbon blacks with different structure indexes or different heat treat temperatures.

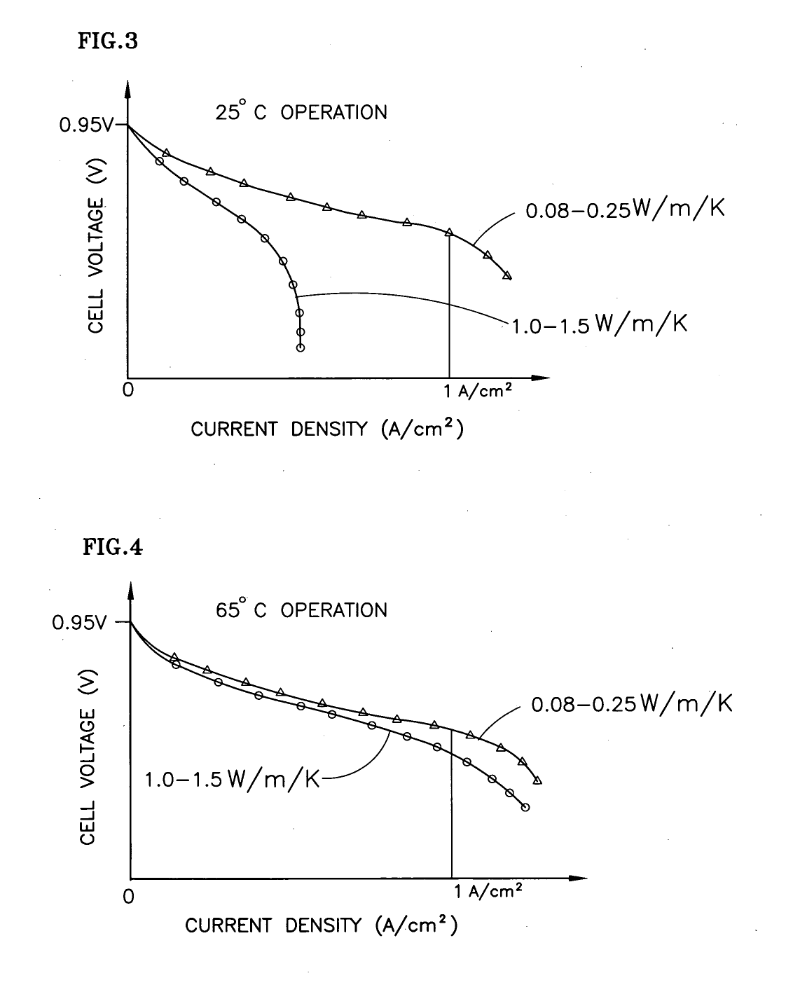

FIG. 3 illustrates that performance commencing at 25C (72F) is very poor when using a typical gas diffusion layer having thermal conductivity above 1.0 W/m/K, in contrast with the acceptable performance achieved with a gas diffusion layer having thermal conductivity less than 0.25 W/m/K.

FIG. 4 shows that utilizing a gas diffusion layer with a significantly lower thermal conductivity is not punitive to normal operation, once the fuel cell achieves normal operating temperature, such as between about 65C (150F) and 80C (175F). In fact, the performance is improved at normal temperature with the gas diffusion layer having the lower thermal conductivity.

1. A fuel cell for a fuel cell power plant which converts hydrogen and oxygen into electricity, heat and water, comprising:
a polymer electrolyte, proton exchange membrane (PEM);
a cathode catalyst layer on a first surface of said PEM;
an anode catalyst layer on a second surface of said PEM opposite to said first surface;
an anode gas diffusion layer adjacent to said anode catalyst and having a through-plane thermal conductivity, said anode gas diffusion layer devoid of a microporous layer;
a cathode gas diffusion layer adjacent to said cathode catalyst and having a through-plane thermal conductivity, said cathode gas diffusion layer devoid of a microporous layer;
a flow field plate having oxidant reactant gas flow field channels therein adjacent to said cathode;
a flow field plate having fuel reactant gas flow field channels therein adjacent to said anode gas diffusion layer;
characterized by:
either or both of said gas diffusion layers having a through-plane thermal conductivity which is less than about 0.25 W/m/K.

2. A fuel cell according to claim 1 further characterized in that:
the thermal conductivity of either or both of said gas diffusion layers is between about 0.08 W/m/K and about 0.25 W/m/K.

3. A fuel cell according to claim 1 further characterized in that:
the thermal conductivity of said cathode gas diffusion layer is between about 0.08 W/m/K and about 0.25 W/m/K and the thermal conductivity of said anode gas diffusion layer is between about 1.0 W/m/K and 1.5 W/m/K.

4. A fuel cell power plant comprised of fuel cells according to claim 1.

5. A fuel cell power plant comprised of fuel cells according to claim 2.

6. A fuel cell power plant comprised of fuel cells according to claim 3.
